(19) United States
(12) Patent Application Publication
(10) Pub. No.: US 2025/0393027 A1
(43) Pub. Date: Dec. 25, 2025

(54) METHODS, ARCHITECTURES, APPARATUSES AND SYSTEMS FOR POWER-SAVING SENSING

(71) Applicant: InterDigital Patent Holdings, Inc., Wilmington, DE (US)

(72) Inventors: Ognen Ognenoski, London (GB); Fumihiro Hasegawa, Westmount (CA); Janet Stern-Berkowitz, Little Neck, NY (US); Ghyslain Pelletier, Montreal (CA); Remun Koirala, London (GB); Paul Marinier, Brossard (CA); Tao Deng, New York, NY (US); Umer Salim, Vallauris (FR); Moon-il Lee, Melville, NY (US); Frank LaSita, Long Beach, NY (US); Kunjan Shah, London (GB)

(21) Appl. No.: 18/749,294

(22) Filed: Jun. 20, 2024

(51) Int. Cl. H04W 68/02; H04L 5/00; H04W 68/00

(52) U.S. Cl. CPC H04W 68/02; H04L 5/0048; H04W 68/005

(57) ABSTRACT

A method performed by a wireless transmit/receive unit (WTRU). The method comprises: receiving, from a wireless network, control information indicative of a paging indication for sensing, a set of synchronization signal block (SSB) indices associated with one or more cell identifiers, and one or more conditions for received SSBs. The method further comprises receiving, from the wireless network, a plurality of SSBs respectively associated with the set of SSB indices, performing one or more measurements on the plurality of SSBs, determining that a first SSB of the plurality of SSBs meets the one or more conditions based on the one or more measurements, wherein the SSB is associated with a first index; and performing sensing measurements based on the first index until a termination condition is detected.

### BACKGROUND

The present disclosure is generally directed to the fields of communications, software and encoding, including, or example, to methods, architectures, apparatuses, systems related to power-saving sensing measurements and sensing-based initial access.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrate a network according to one or more embodiment;

FIG. 3 illustrate measurement samples according to one or more embodiment;

FIG. 4 illustrates a network according to one or more embodiment;

FIG. 5 is a flow chart illustrating a process according to one or more embodiments;

FIG. 6 is a flow chart illustrating a method for power-saving sensing according to one or more embodiment;

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

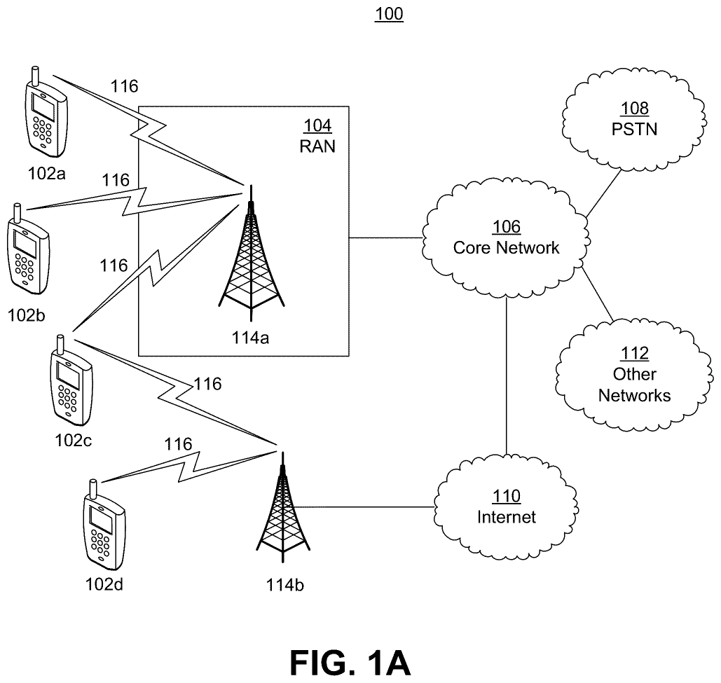

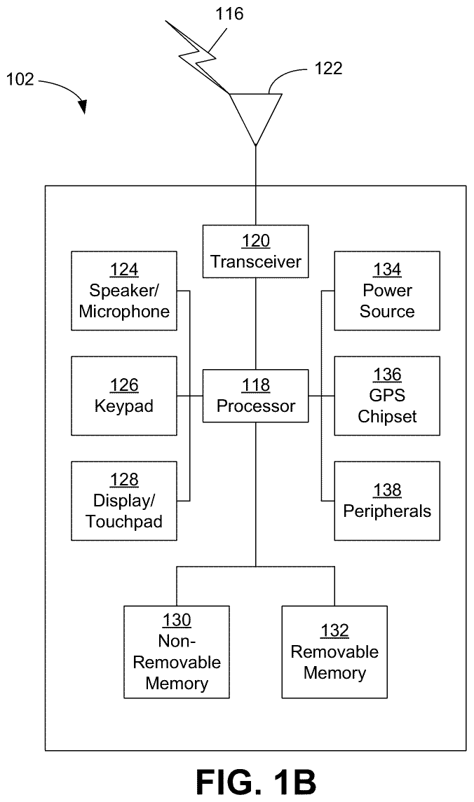

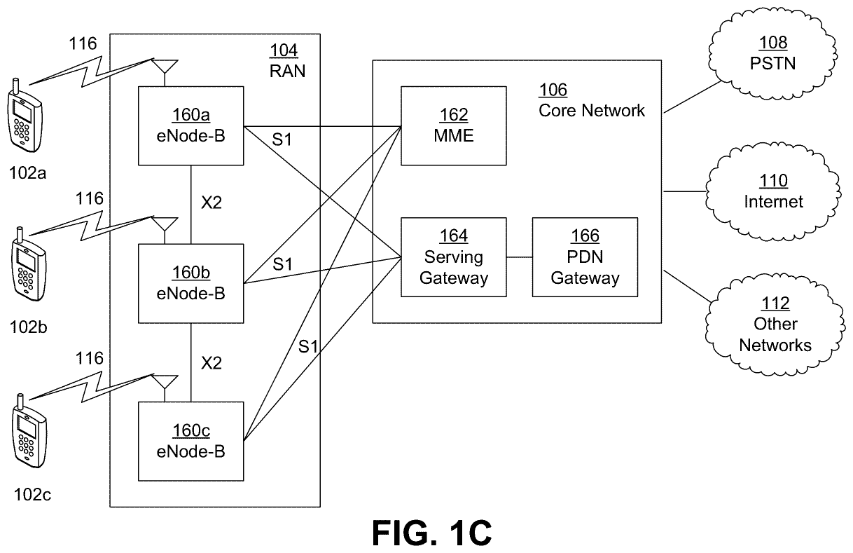

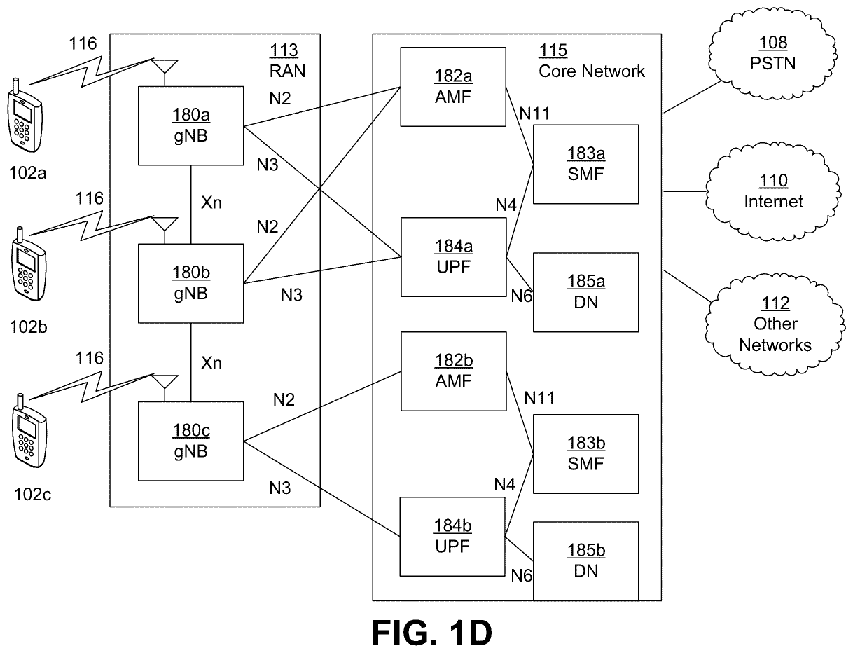

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

In certain representative embodiments, several aspects for a New Radio (NR) positioning for WTRUs in Radio Resource Control (RRC) INACTIVE state are provided. The aspects may comprise enabling positioning in RRC INACTIVE state. Further, Downlink (DL) positioning measurements in RRC IDLE as well as procedures feasible for DL positioning methods in RRC IDLE state are provided. Low Power High Accuracy Positioning (LPHAP) performance requirements are stated, and the main objective of LPHAP evaluation from lower layers perspective is WTRU power consumption. The WTRU power consumption may be important aspect for developing NR positioning technology.

In certain representative embodiments, energy efficiency requirements for sensing for Unmanned Aerial Vehicle (UAV) flight trajectory tracing and intruder detection are provided. In certain representative embodiments, examples of energy efficient sensing operations in a 5G system may include temporarily disabling sensing transmitters and receivers that are not involved in sensing and communication operation and adjusting sensing operations parameters such as sensing frequency. Additional examples may include if UAV X leaves coverage of an old base station and enters coverage of a new base station, the old base station may stop radio sensing and operate in power saving mode. Furthermore, the network operation Mobility Management (MM) may configure energy consumption sensing mode with different sensing period, e.g., operate sensing one time per 50 seconds, per 10 seconds, etc.

In certain representative embodiments, a stationary customer premises equipment (CPE) may be deployed at home for intruder detection (for example close to an entrance door). The CPE/ATRU may support intruder detection sensing service in coordination with a gNB, and to conserve battery power by using the limited available signals and resources. For example, the intruder may be detected by observing changes in the measurements on the synchronisation signals when the intruder enters the environment.

In certain representative embodiments, each of the sensing use cases (e.g., intruder detection) may be provided with a set of QoS parameters such as sensing service area, confidence level, sensing resolution, etc. In certain representative embodiments, for the intruder detection, the following parameters may be given: accuracy of positioning estimate by sensing (<10 m), max sensing service latency (<1000 ms), refreshing rate (<1 s), missed detection (<5%), and false alarm (<2).

In certain representative embodiments, minimizing power consumption for sensing services may be minimized.

In certain representative embodiments, a WTRU may be configured to run sensing applications/services with different Quality of the Service (QoS) parameters. Transition from IDLE/INACTIVE mode towards CONNECTED mode for sensing purposes may be energy consuming for battery-operated CPE/WTRU. The CPE/WTRU may be registered in IDLE mode. In certain representative embodiments, power consumption may be minimized for CPE/WTRUs that may be configured to run sensing services. Currently, systems may not support power consumption friendly access for CPE/WTRUs that are running sensing services. The lightweight access may allow the WTRUs to report their sensory data or measurements to the Network (NW). In certain representative embodiments, techniques for power saving while enabling positioning may be used as a basis for the sensing techniques.

Throughout the embodiments described herein, a network may include any of a base station (e.g. gNB, Transmission-Reception Point (TRP), Radio Access Network (RAN) node, access node), core network function (e.g. Access and Mobility Function (AMF), Session Management Function (SMF), Policy Control Function (PCF), Network Exposure Function (NEF)) and application function (e.g. edge server function, remote server function).

Throughout the embodiments described herein, an ambiguity/uncertainty/inexactness refers to ambiguity calculation, where the output of the calculation may not an exact value, rather it is a value accompanied with a level of certainty, expressed and not limited to confidence intervals, probability, accuracy, etc.

Throughout the embodiments described herein, an ambiguity/uncertainty/inexactness threshold refers to a threshold value which may be compared to the output value of the ambiguity calculation.

Throughout the embodiments described herein, configurations/configs for ambiguity calculation refers to all 3GPP configurations that may be used for conducting ambiguity calculations such as configurations determining AI models, empirical or probabilistic models, where the input is measurements (for example multipath measurements) and the output is association of measurements with obstacle and number and obstacle(s) location(s).

Throughout the embodiments described herein, multipath measurements refers to measurements such as Reference Signal Time Difference (RSTD) or Reference Signal Received Power (RSRP), however performed on the same (for example PRS) signal. The measurements may be conducted to obtain the time difference and the power difference between the direct component in the channel impulse response and all the remaining measured components from the channel impulse response. The multipath measurements adopted in this disclosure may use the ambiguity of the multipath in order to determine the number and obstacle(s) location(s).

Throughout the embodiments described herein, main data may refer to information discerned as a result of using configurations and multipath measurements in ambiguity calculations, and consists of any of the following: associated multipath measurements (RSTD/RSRP) to obstacle(s), number and obstacle(s) location(s).

Throughout the embodiments described herein, auxiliary data may refer to information relevant for performing ambiguity calculations and consist of any of the following: number of best beams out of the total number of beams, set or subset of the configurations and multipath measurements.

Throughout the embodiments described herein, PRS configuration may refer to the configuration of the PRS signal and may include the structure hierarchy of the positioning frequency layer, resource information set, and resource elements spanned across the time/frequency grid.

In this disclosure, “Network” may include AMF, LMF, gNB or NG-RAN. “Pre-configuration” and “configuration” may be used interchangeably. “non-serving gNB” and “neighboring gNB” may be used interchangeably. “gNB” and “TRP” may be used interchangeably. “PRS”, “Sounding Reference Signal (SRS)”, “SRS for positioning” or “SRS for positioning purpose” may be used interchangeably. “PRS” or “PRS resource” may be used interchangeably. “PRS(s)” or “PRS resource(s)” may be used interchangeably. The aforementioned “PRS(s)” or “PRS resource(s)” may belong to different PRS resource sets. “PRS” or “DL-PRS” or “DL PRS” may be used interchangeably. “Measurement gap” or “Measurement gap pattern” may be used interchangeably. “Measurement gap pattern” may include parameters such as measurement gap duration or measurement gap repetition period or measurement gap periodicity. A PRU may be a WTRU or TRP whose location (e.g., altitude, latitude, geographic coordinate, or local coordinate) may be known by the network (e.g., gNB, LMF). Capabilities of PRU may be same as a WTRU or TRP, e.g., capable of receiving PRS or transmit SRS or SRS for positioning, return measurements, or transmit PRS. The WTRUs acting as PRUs may be used by the network for calibration purposes (e.g., correct unknown timing offset, correct unknown angle offset). An Location Management Function (LMF) is a non-limiting example of a node or entity (e.g., network node or entity) that may be used for or to support positioning. Any other node or entity may be substituted for LMF and still be consistent with this disclosure. The WTRU may receive a preconfigured threshold(s) from the network (e.g., LMF, gNB). A Line-of-Sight (LOS) indicator may be hard (e.g., 1 or 0) or soft indicator (e.g., 0, 0.1, 0.2 . . . , 1) and it may indicate likelihood of the presence of an LOS path between TRP and WTRU or along PRS. The LOS indicator may be associated with a TRP or PRS resource ID (e.g., index). The WTRU may receive the LOS indicator from the network per TRP or resource ID. Alternatively, the WTRU may determine the LOS indicator per TRP or resource ID based on measurements. A WTRU location may be expressed in terms of altitude, latitude, geographic coordinate, or local coordinate, for example.

In certain representative embodiments, a method for power saving sensing services as a function of sensing measurements and modified initial access based on sensing cause is provided.

In certain representative embodiments, a WTRU may receive, from a network (e.g., gNB, Location Management Function (LMF)), via a broadcast message at least one of: a first set(s) of Synchronization Signal Block (SSB) indices associated with a cell ID(s) and association between Physical Random Access Channel (PRACH) resources and preambles, and the SSB indices in the first set.

The WTRU may receive, from the network, a paging indication for sensing, Reference Signal Received Power (RSRP) threshold, and configuration for sensing in System Information Block (SIB) via broadcast message where the configuration may indicate a second set of SSB indices and associated cell IDs for measurements. The second set of SSBs may be a subset of the first set of SSB indices. The SIB may contain the first set and the second set of SSB indices

The WTRU may determine a first SSB index from the second SSB set for which a trigger condition may be met. An example of satisfied trigger condition may be the following: if a change in RSRP measurement for a given SSB index is greater than a RSRP threshold. If the trigger condition is met, the WTRU may determine a second SSB index with the highest RSRP from the first set of SSB indices and may send the configured preamble on the PRACH resource associated with the second SSB index.

If the WTRU receives a Random Access Response (RAR) from the network, the WTRU may include RRC connection request with a new cause (e.g., sensing), first SSB index and associated cell ID, and the measured RSRP change for meeting the trigger condition, in msg3.

If the WTRU receives msg4 from the network, the WTRU may determine Downlink-Reference Signal (DL-RS) configurations for measurements from msg4.

If contention is not resolved (e.g., contention timer expires, the WTRU does not receive msg4), the WTRU may keep measuring the configured second set of SSBs until it receives a broadcast message indicating termination of sensing from the network.

If the trigger condition is not met, the WTRU may keep measuring configured second set of SSBs until it receives a broadcast message indicating termination of sensing from the network.

In certain representative embodiments, power saving for sensing services may be facilitated by using measurements in IDLE/INACTIVE mode and using sensing-specific initial access.

In certain representative embodiments, a WTRU may perform power-saving measurements (in IDLE/INACTIVE mode) and access procedure related to sensing service (e.g., intruder detection).

### Configurations for RS for Positioning

In certain representative embodiments, a WTRU may receive PRS and/or SRS configurations for positioning purpose from a network (e.g., LMF). The LMF may forward the PRS configuration and SRS configurations to the gNB so that the gNB can schedule PRS transmission or SRS reception at the TRP, TP and/or RP.

### Configurations for PRS

In certain representative embodiments, a PRS configuration may contain at least one of the following parameters: number of symbols, transmission power, number of PRS resources included in PRS resource set, muting pattern for PRS (for example, the muting pattern may be expressed via a bitmap), periodicity, type of PRS (e.g., periodic, semi-persistent, or aperiodic), slot offset for periodic transmission for PRS, vertical shift of PRS pattern in the frequency domain, time gap during repetition, repetition factor, RE (resource element) offset, comb pattern, comb size, spatial relation (e.g., with respect to other PRSs or UL RS such as SRS for positioning purpose), Quasi-Colocation (QCL) information (e.g., QCL target, QCL source) for PRS, number of TRPs, Absolute Radio-Frequency Channel Number (ARFCN), subcarrier spacing, expected RSTD, uncertainty in expected RSTD, start Physical Resource Block (PRB), bandwidth, BWP ID, number of frequency layers, start/end time for PRS transmission, on/off indicator for PRS, TRP ID, PRS ID, cell ID, global cell ID and applicable time window. The ETRU may apply a PRS configuration under a condition that the current time is within the applicable time window. “ID” may be used interchangeably with “index”.

### Configurations for SRS for Positioning

In certain representative embodiments, SRS for positioning (SRSp) or SRS configuration may include at least one of: resource ID; comb offset values, cyclic shift values; start position in the frequency domain; number of SRSp symbols; shift in the frequency domain for SRSp; frequency hopping pattern; type of SRSp (e.g., aperiodic, semi-persistent or periodic); sequence ID used to generate SRSp, or other IDs used to generate SRSp sequence; spatial relation information, indicating which reference signal (e.g., DL RS, UL RS, CSI-RS, SRS, DM-RS) or SSB (e.g., SSB ID, cell ID of the SSB) the SRSp is related to spatially where the SRSp and DL RS may be aligned spatially; QCL information (e.g., a QCL relationship between SRSp and other reference signals or SSB); QCL type (e.g., QCL type A, QCL type B, QCL type C, QCL type D); resource set ID; list of SRSp resources in the resource set; transmission power related information; pathloss reference information which may contain index for SSB, CSI-RS or PRS; periodicity of SRSp transmission; and/or spatial information such as spatial direction information of SRSp transmission (e.g., beam information, angles of transmission), spatial direction information of DL RS reception (e.g., beam ID used to receive DL RS, angle of arrival). “ID” may be used interchangeably with “index”.

### Initial Configuration

In certain representative embodiments, In an initial configuration, a WTRU may be registered to an NW and may be in RRC IDLE/INACTIVE state, and it may receive from the NW, for example from the gNB or from the LMF a broadcast message that contains information about the following: 1) A first set of SSB indices associated with a cell IDs, and 2) association between PRACH resources and preambles, and the first set of SSB indices. In certain representative embodiments, the first set of SSB indices may contain N indices (for example SSB_indices=1, 2, . . . , N) that are all associated with a single cell ID (for example cell_ID=1). In another example, the first set of SSB indices may contain N indices (for example SSB_indices=1, 2, . . . , N) associated with M cell IDs (cell_ID=1, 2, . . . , M), where if N=4 and M=2, one option may be that SSB_indices=1,2 are associated to cell_ID=1 and SSB_indices=3,4 are associated to cell_ID=2. The association between the PRACH resources and preambles with the first set of SSB indices may be used for RRC connection establishment. In certain representative embodiments, the WTRU may use the SSBs associated with the first set of SSB indices to determine transmission configurations (e.g., Tx or Rx beam direction) for messages transmitted to the network (e.g., msg 3, msg 5).

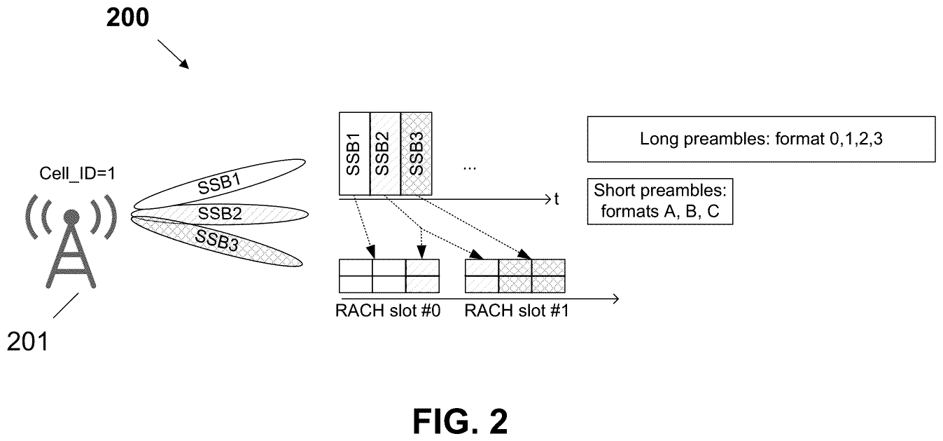

In the association, the SSBs are mapped to Random Access Channel (RACH) time and frequency occasions. FIG. 2 illustrate a network 200 according to one or more embodiment. The network 200 may include a cell 201 comprising a cell_ID=1. In this embodiment, there is provided 3 SSBs, 2 RACH frequency occasions, 2 RACH time occasions, and each SSB index may be associated with 4 RACH.

In certain representative embodiments, the number of SSB time indices per RACH time/frequency occasion may be specified by the RA configuration of a cell. In addition to being associated to a specific random-access occasion, the SSB index may be associated to a specific set of preambles since each preamble is defined in each time-frequency PRACH occasion. The preamble may consist of two parts: Cyclic Prefix (CP) and preamble sequence, and there are short and long preamble categories with different formats, where the difference in the time domain of the different formats is in the different CP length, sequence length, and the number of repetitions.

In certain representative embodiments, the WTRU may use a short preamble (e.g., transmitted over 5 symbols) for intruder detection because the max latency of the intruder detection sensing service is 1000 ms, whereas the WTRU may use a long preamble (e.g., transmitted over 15 symbols) for UAV trajectory tracking because the max latency of the UAV trajectory tracking service is 3000 ms. The WTRU may send a preamble for indication of detection (e.g., detection indicating preamble) where preambles for indicating detection are different from the long and short preambles used for the traditional initial access for communication services. The detection indicating preambles may be generated using different sequences, random number generator with different seeds, etc.

In certain representative embodiments, the WTRU may be configured with a set of downlink reference signals (DL-RS), e.g., CSI-RS, PRS to monitor. The WTRU may receive configurations for DL-RS (e.g., PRS resource IDs, CSI-RS resource IDs). The WTRU may receive the reconfiguration via a RRC or LPP message, for example. The WTRU may receive a request from the network (e.g., via RRC or LPP message) to monitor the indicated DL-RS resources. The WTRU may receive configurations of the DL-RS resources (e.g., DL-RS resource ID) to monitor or make measurements. The WTRU may send a response (e.g., accept or reject the request) to the network via RRC or LPP message.

### Sensing Request Reception

In certain representative embodiments, in the reception of the sensing request, the WTRU may receive several parameters/information such as a paging indication, RSRP threshold (i.e., trigger condition), and specific configuration for sensing for example in SIB via broadcast, where the specific configuration indicates a second set of SSB indices. The paging indication is broadcasted to all WTRUs that are required or requested to participate in the sensing. In one example, the broadcast message (e.g., via RRC) from the network may contain a request to perform sensing.

In certain representative embodiments, the WTRU may receive configurations for the second set of SSB indices, e.g., cell IDs, TRP IDs, sequence IDs, SSB indices. The WTRU may receive details related to configurations for SSB in the second set in the same broadcast message that contains the details for configurations for SSB in the first set. In certain representative embodiments, the WTRU may receive details related to configurations for SSB in the second set in a different broadcast message that contains the details for configurations for SSB in the first set.

Examples of triggers conditions may be the following. For example, the trigger condition may be satisfied when at least one of the following is met: RSRP of the SSB the WTRU is monitoring falls below the threshold, difference between the reference RSRP (e.g., average RSRP) and RSRP of the SSB the WTRU is monitoring is above or equal to the threshold, change in RSRP compared to the reference RSRP (e.g., average RSRP, RSRP measured at the previous occasion) is above or equal to the threshold.

The RSRP threshold may be only one example of trigger condition In certain representative embodiments, different measurement or different multiple measurements thresholds may be used. These may be service-specific, for example RSRP_Threshold1 may be used for intruder detection services, whereas RSRP_Threshold2 may be used for UAV trajectory tracing services. Further, a measurement such as RSTD may be used to determine the presence of the intruder with a specific RSTD_threshold1, and/or a combination of RSRP and RSTD measurements with RSRP_threshold and RSTD_threshold may be used. In addition, the comparison of the threshold for example for RSRP can be defined with respect to a reference measurement (e.g., an average RSRP (e.g., moving average RSRP)) for a given SSB. In certain representative embodiments, the reference RSRP may be the average RSRP or RSRP of SSB measured in the last occasion the WTRU received the SSB.

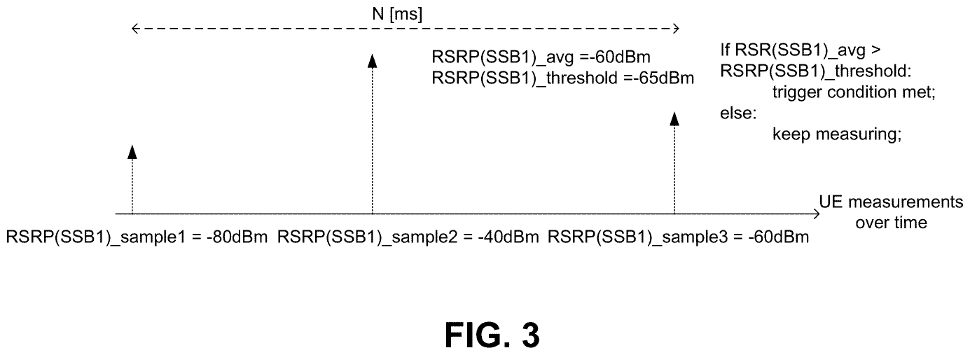

FIG. 3 illustrate measurement samples according to one or more embodiment. The measurement samples comprise three measurement RSRP samples at the WTRU within N ms, including the RSRP average value, the RSRP threshold and the if-else logic for the trigger condition. In addition, a change, i.e., satisfied trigger condition may be declared if it happens for N consecutive measurement occasions. The measurement duration may also be associated to the QoS parameter of the sensing services, for example for intruder detection RSRP measurement per SSB is made within N ms, for UAV trajectory tracking RSRP measurement per SSB is made within M ms. In certain representative embodiment, the WTRU may be configured with a window with start and/or end time, or duration (e.g., expressed in terms of ms, number of symbols, slots, frames, subframes). The WTRU may determine the average RSRP of a SSB during the RSRP or power measurement made during the window.

In certain representative embodiments, the second set of SSB indices associated to cell IDs, and the first set of SSB indices associated to cell IDs in accordance to one or more embodiments described above, both may be passed in the SIB broadcast to the WTRU. The first set of SSBs indices and the second SSBs indices may be disjoint, i.e., without any common elements. In certain representative embodiments, the second set of SSBs indices may be a subset of the first set of SSB indices, i.e., all elements from the second set of SSB indices may be found in the first set of SSB indices. In certain representative embodiments, few elements of the second set of SSB indices may be found in the first set of SSB indices.

### Sensing Measurements and Sensing-Based Access

The WTRU may start the measurements using the configuration information received in in accordance to one or more embodiments described above. From the second subset of SSBs, the WTRU may determine the first SSB index for which the trigger condition is met, for example if the RSRP measurement on that SSB index is greater than RSRP threshold. In certain representative embodiments, the WTRU may determine an SSB index whose difference in RSRP with respect to the reference RSRP (e.g., average RSRP) may be greater than the threshold. For example, if the RSRP of the SSB, average RSRP and thresholds are −60 dBm, −40 dBm, and 10 dBm, the WTRU may determine that the trigger condition is met. In certain representative embodiments, the WTRU may determine multiple SSBs from the second set of SSB indices for which the trigger condition is met. In such case, the WTRU may determine to select only the SSB with the largest RSRP margin (i.e., drop) with respect to the RSRP threshold, or it may select few (e.g., N SSBs where N is the configured number of SSBs to select), or select all SSBs for which the trigger condition is met. The selected SSBs in this step are then reported to the NW. In certain representative embodiments, the WTRU may determine to select N SSBs with the highest difference between respective RSRP and reference RSRP. The WTRU may receive thresholds described herein from the network.

The WTRU additionally performs measurements on the SSB from the first set of SSB indices, but this is only done if the trigger condition is met, i.e., there is at least one selected SSB based on the measurements performed on the second set of SSB indices. If there is no selected SSB from the second set of SSBs, then the WTRU does not perform measurements on the first set of SSBs. Otherwise, the WTRU may measure and determine a second SSB index with the highest RSRP (or different measurement metric, or combination of multiple metrics) from the first set of SSB indices. There is only one determined second SSB index from the first set of SSB indices. The determined second SSB index is used to transmit the configured preamble on the PRACH resources associated to the second SSB index.

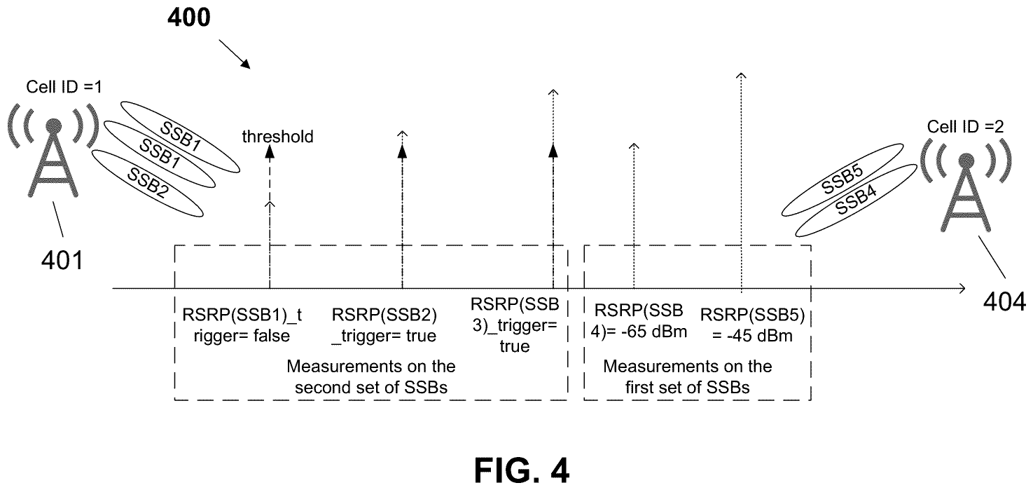

FIG. 4 illustrates a network 400 according to one or more embodiment. The network 400 comprises a first cell 401 comprising a cell-ID=1 and a second cell 404 comprising cell-ID=2. As illustrated, measurements are performed on the second set of SSBs that are used to check if the trigger condition is valid and measurements performed on the first set of SSBs where the first and the second subset of SSBs are disjoint. In this example, only one SSB index from the second set of SSBs may be selected, i.e., SSB3 because it meets the trigger condition and the margin with respect to the threshold is larger compared to the case for SSB2. Furthermore, from the first set of SSBs, the SSB5 index has higher RSRP compared to SSB4 index, and it is selected for transmitting the configured preamble and on the PRACH resources associated to SSB5.

Upon transmission of the preamble on the PRACH resources, the WTRU may receive a Random Access Response (RAR) message from the NW containing timing advance command, UL grant PUSCH allocation for msg3 (resource index, MCS, TPC, CSI request, etc) for the WTRU to transmit back to the NW specific information related to the sensing service. In certain representative embodiments, the WTRU may receive the RAR from the NW, which is followed by at lease on of the following steps: the WTRU may respond to the NW with RRC connection request with the following type of information: a new cause (for example sensing cause) indicating the cause why the RRC connection request is sent. This is for the WTRU to indicate to the NW that it requires sensing-specific access to the NW for transmitting sensing related information. Then, the first SSB index (from the second SSB set) and its associated cell ID, the measured RSRP change observed for meeting the trigger condition can be transmitted in msg3 as a sensing specific information relevant for the NW. In msg3, all the variations such as multiple SSBs for which the criteria are met, all the SSBs for which the criteria are met as well as all RSRP (or other related measurements such as RSTD) measurements may be transmitted to the NW. In certain representative embodiments, the WTRU may report the RSRP measured for the first SSB index and/or determined reference RSRP (e.g., average RSRP) to the network in msg3. In certain representative embodiments the WTRU may indicate in msg 3 the SSB index.

The WTRU may receive msg4 from the NW such that the WTRU may determine DL-RS configurations for measurements from msg4. These measurements may provide more detailed information about the sensing service such as improving the sensing resolution, accuracy, etc. The DL-RS configurations may be CSI configurations and/or PRS configurations, and/or any type of configurations for signals in the system that are used for sensing. In addition, the received msg4 may contain request for additional information related to the sensing service or additional information for measurements or threshold criteria.

In certain representative embodiments, the WTRU may determine to transmit the preamble or UL RS without an attempt to report measurement results to the network. The preamble may be associated with the SSB which satisfies the trigger condition (e.g., difference between the reference RSRP and RSRP of the SSB is monitoring (target RSRP) is above the threshold), and the network may determine from the reception of the SSB that the WTRU detected an object which may be the cause of the change in RSRP. For example, the WTRU may determine to transmit the preamble that is associated with an SSB which met the trigger condition (e.g., RSRP below the threshold, difference between the target RSRP and reference RSRP is above the threshold). The WTRU may determine to transmit the preamble until the WTRU may receive an acknowledgement message from the network. In certain representative embodiments, the WTRU may determine to transmit the preamble at configured periodicity or for the configured number of occasions. In certain representative embodiments, the WTRU may determine to transmit the preamble semi persistently, (e.g., during a configured window or duration periodically). The WTRU may receive such configurations via an RRC message (e.g., broadcast message).

In certain representative embodiments, the WTRU may receive thresholds from the network. The WTRU may determine that if one of the DL-RSs the WTRU is monitoring satisfies the trigger condition (e.g., RSRP of the DL-RS is below the threshold), the WTRU may send a report to the network via UCI, MAC-CE or RRC message in PDCCH or PDSCH. The report may contain at least one of the following: DL-RS resource ID where the DL-RS resource ID corresponds to the ID of the DL-RS which satisfied the trigger condition, measurement (e.g., change in RSRP, RSRP measurement), for example.

In certain representative embodiments, the WTRU may determine to transmit UL RS that is associated with the DL-RS that satisfied the trigger condition. For example, if CSI-RS #2 and SRS #3 are associated and the measurement of CSI-RS #2 satisfies the trigger condition (e.g., RSRP is below the threshold), the WTRU may determine to transmit SRS #3. The WTRU may receive association information between DL RS and UL RS from the network. The WTRU may determine to transmit the associated UL-RS for a configured number of occasions. The WTRU may determine to transmit the associated UL-RS periodically or semi-persistently (e.g., periodically during a window). The WTRU may receive configurations for the window (e.g., start or end time expressed in terms of absolute time, SFN, slot number, frame number,symbol number, duration expressed in terms of the number of symbols, slots, frames or seconds) from the network.

### Termination Condition

In certain representative embodiments, a power-saving sensing measurements and sensing-based initial access method is provided. The power-saving sensing measurements may terminate by receiving a broadcast message from the NW that indicates to the WTRU that the sensing service needs to be terminated. In this message, ID or description information for the service may be carried. There may be two termination conditions that lead to termination of the sensing service from the NW. In the first case, if the contention is not resolved, for example if preconfigured contention timer expires or the WTRU does not receive msg4, then the WTRU keeps measuring the configured second set of SSBs until it receives a broadcast message from the NW. This broadcast message indicates termination of the sensing service, and the WTRU stops to measure.

The second condition that may lead to termination of the sensing service is when there is no trigger condition that is met while measuring the configured set of SSBs. In this case, the WTRU keeps measuring the SSBs until it receives a broadcast message from the NW that indicates termination of the sensing service which results in the WTRU to stop measuring.

In certain representative embodiments, the WTRU may receive a termination message from the network (e.g., LMF, gNB) which indicates to stop monitoring or measuring the preconfigured or configured set of SSBs (e.g., first or second set of SSBs). In certain representative embodiments, the WTRU may start a timer when the WTRU receives a message from the network to start measuring or monitoring the preconfigured or configured set of SSBs. If the timer expires or reaches the preconfigured or configured time limit, the WTRU may determine to stop measuring or monitoring the configured set of SSBs.

In certain representative embodiments, the WTRU may determine to stop measuring or monitoring the configured set of SSBs if the WTRU moves out of the area (e.g., cell). For example, if the WTRU moves out of the cell where the WTRU was monitoring or measuring the configured set of SSBs, the WTRU may determine to stop monitoring or measuring the configured set of SSBs.

If the WTRU determines to stop monitoring or measuring the configured set of SSBs for the purpose of sensing, the WTRU may determine to report or indicate to the network using the preamble sequence, msg3 or subsequent messages needed for resolving contention or completing the random access. For example in the message, the WTRU may indicate the cause of the termination of monitoring or measurement (e.g., timer reached the expiration time, the WTRU moves out of the area). The WTRU may determine to transmit a configured preamble sequence at associated time and/or frequency resources to the network when the WTRU determines to stop monitoring or measuring the configured set of SSBs.

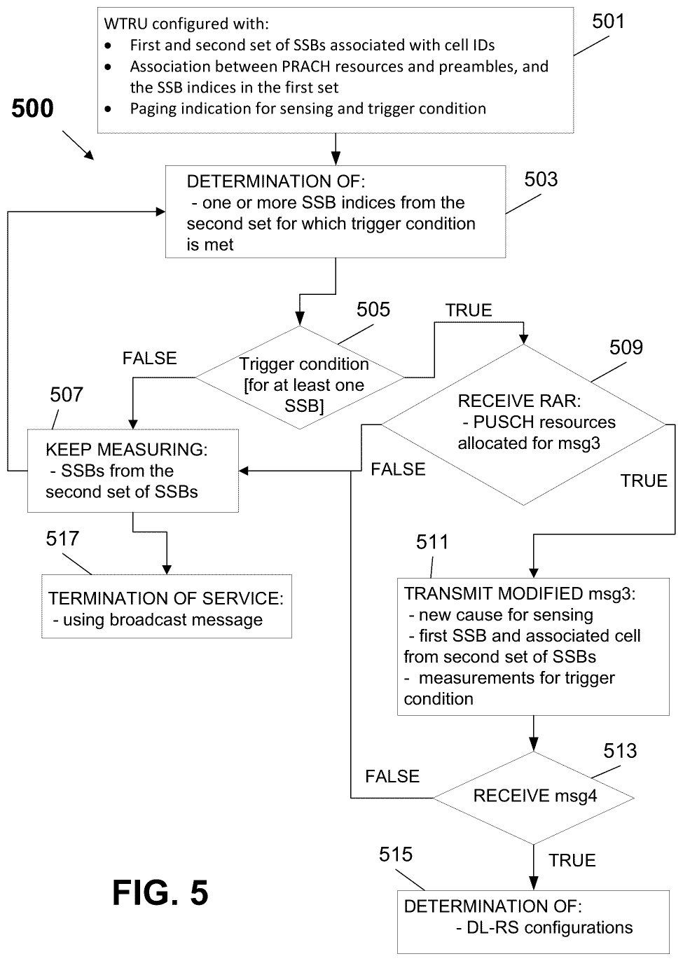

FIG. 5 is a flow chart illustrating a process 500 according to one or more embodiments. The process 500 illustrates one or more steps and information from a perspective of a WTRU. At step 501, the WTRU may be configured with first and second set of SSBs indices (and their associated cell IDs), and with association between PRACH resources, preambles and the first set of SSB indices. In addition, the WTRU may receive a paging indication for sensing and configuration information for checking a trigger condition. At step 503, using the configured information, the WTRU may determine one or more SSB indices from the second set of SSBs for which the trigger condition is met. In this exemplary embodiment, only one SSB index is selected, for example one where the difference between the measured RSRP on the SSB and the RSRP threshold value is the largest. At step 505, if the trigger condition is not met for at least one of the SSBs, the process 500 proceeds to step 507, the WTRU keeps performing measurements on the second set of SSBs and subsequently returns to step 503. However, if the trigger condition is met for at least one of the SSBs, the WTRU may identify the best SSB index from the first set of SSBs (for example, SSB index with highest RSRP measurement) and transmits the associated preamble on the associated PRACH resources for the best SSB index. The process 500 then proceeds to step 509. At step 509, the WTRU may receive or it may not receive RAR from the NW. If RAR not being received, the process 500 returns to step 507 and the WTRU keeps measuring the SSBs from the second set of SSB indexes. If it is determined that RAR is being received (with PUSCH resources for transmission of msg3), at step 511, the WTRU may transmit msg3 with new cause for sensing (indicating that it wants to obtain access to the NW for the purpose of reporting information for a sensing service), the selected SSB index from the second set of SSB indices that meets the trigger condition, and the measurements that caused the trigger condition to be met. Next, at step 513, the WTRU may receive or it may not receive msg4. In case of not receiving msg4, the process 500 returns to step 507. In the case of receiving msg4, the WTRU may use msg4 to determine DL-RS configurations for additional measurements for the sensing service at step 515. The termination of the sensing service may happen with a termination broadcast message send from the NW to the WTRU at step 517 when the WTRU is measuring SSBs indices from the second set of SSB indices at step 507.

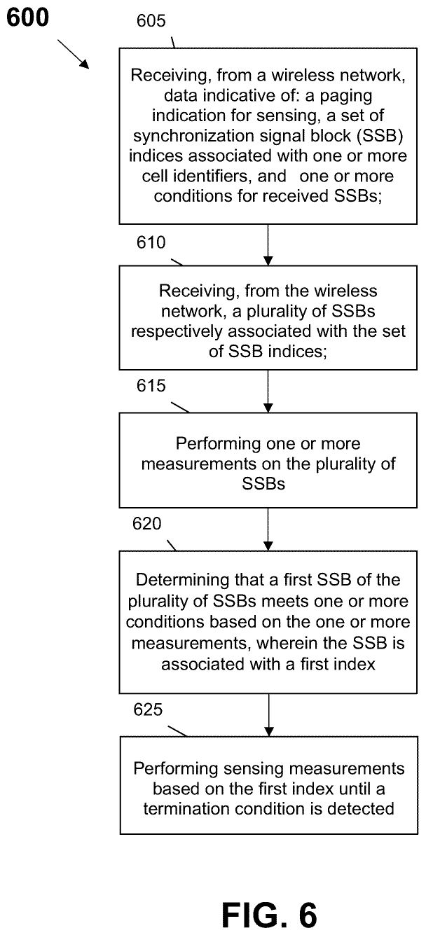

FIG. 6 is a flow chart illustrating a method 600 for power-saving sensing according to one or more embodiment. The method 600 may be performed by a wireless transmit/receive unit (WTRU). The method 600 may include receiving 605, from a wireless network, control information indicative of: a paging indication for sensing, a set of synchronization signal block (SSB) indices associated with one or more cell identifiers, and one or more conditions for received SSBs. The method 600 may include receiving 610, from the wireless network, a plurality of SSBs respectively associated with the set of SSB indices. The method 600 may include performing 615 one or more measurements on the plurality of SSB. The method 600 may include determining 620 that a first SSB of the plurality of SSBs meets the one or more conditions based on the one or more measurements, wherein the SSB is associated with a first index. The method 600 may include performing 625, sensing measurements based on the first index until a termination condition is detected.

In some implementations, the one or more conditions are based on at least one of a reference signal received power (RSRP) threshold or a reference signal time difference (RSTD) threshold.

In some implementations, the one or more measurements comprise reference signal received power (RSRP) measurements for each of the plurality of SSBs, and wherein the one or more conditions comprise a change in RSRP measurements for an SSB associated with an index exceeding a threshold.

In some implementations, a second SSB associated with a second index is determined, and a configured preamble on a Physical Random Access Channel (PRACH) resource associated with the second SSB is transmitted, to the wireless network, using the second SSB.

In some implementations, the set of SSB indices is a first set of SSB indices, and configuration information indicative of a second set of SSB indices associated with one or more cell identifiers is received, wherein determining the second SSB associated with the second index comprises measuring an SSB with the highest reference signal received power (RSRP) in the second set of SSB indices.

In some implementations, the first set of SSB indices is a subset of the second set of SSB indices.

In some implementations, first information associated with the sensing measurements is transmitted to the wireless network.

In some implementations, the first information associated with the sensing measurements comprise information indicating a cause of a connection request, the SSB associated with the first index and an associated cell identifier, and the measurements associated with the one or more conditions.

In some implementations, second information comprising at least one Downlink-Reference Signal (DL-RS) configurations identifier is transmitted to the wireless network.

In some implementations, the termination condition comprises at least one of receiving a message from the wireless network indicating termination of the sensing measurements, an expiry of a time period or a loss of connection to the one or more cells.

The contents of the following reference is incorporated by reference herein in their entireties: [1] TS 38.321 v17.2.0, Section 5.4.3.1, 2022/10.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), the method comprising:
receiving, from a wireless network, control information indicative of:
a paging indication for sensing,
a set of synchronization signal block (SSB) indices associated with one or more cell identifiers, and
one or more conditions for received SSBs;
receiving, from the wireless network, a plurality of SSBs respectively associated with the set of SSB indices;
performing one or more measurements on the plurality of SSBs;
determining that a first SSB of the plurality of SSBs meets the one or more conditions based on the one or more measurements, wherein the first SSB is associated with a first index; and
performing sensing measurements based on the first index until a termination condition is detected.

2. The method of claim 1, wherein the one or more conditions are based on at least one of a reference signal received power (RSRP) threshold or a reference signal time difference (RSTD) threshold.

3. The method of claim 1, wherein the one or more measurements comprise reference signal received power (RSRP) measurements for each of the plurality of SSBs, and wherein the one or more conditions comprise a change in RSRP measurements for an SSB associated with an index exceeding a threshold.

4. The method of claim 1, further comprising:
determining a second SSB associated with a second index, and
transmitting, to the wireless network, using the second SSB associated with the second index, a configured preamble on a Physical Random Access Channel (PRACH) resource associated with the second SSB.

5. The method of claim 4, wherein the set of SSB indices is a first set of SSB indices, and the method further comprising:
receiving configuration information indicative of a second set of SSB indices associated with one or more cell identifiers, wherein determining the second SSB associated with the second index comprises measuring an SSB with highest reference signal received power (RSRP) in the second set of SSB indices.

6. The method of claim 5, wherein the first set of SSB indices is a subset of the second set of SSB indices.

7. The method of claim 4, further comprising:
transmitting, to the wireless network, first information associated with the sensing measurements.

8. The method of claim 7, wherein the first information associated with the sensing measurements comprises information indicating a cause of a connection request, the SSB associated with the first index and an associated cell identifier, and the measurements.

9. The method of claim 7, further comprising:
transmitting, to the wireless network, second information comprising at least one Downlink-Reference Signal (DL-RS) configuration identifier.

10. The method of claim 1, wherein the termination condition comprises at least one of receiving a message from the wireless network indicating termination of the sensing measurements, an expiry of a time period or a loss of connection to the one or more cells.

11. A wireless transmit/receive unit (WTRU) comprising:
a processer, and
a transceiver coupled to the processer, wherein the WTRU is to:
receive, from a wireless network, control information indicative of:
a paging indication for sensing,
a set of synchronization signal block (SSB) indices associated with one or more cell identifiers, and
one or more conditions for received SSBs;
receive, from the wireless network, a plurality of SSBs respectively associated with the set of SSB indices;
perform one or more measurements on the plurality of SSBs;
determine that a first SSB of the plurality of SSBs meets the one or more conditions based on the one or more measurements, wherein the first SSB is associated with a first index; and
perform sensing measurements based on the first index until a termination condition is detected.

12. The WTRU of claim 11, wherein the one or more conditions are based on at least one of a reference signal received power (RSRP) threshold or a reference signal time difference (RSTD) threshold.

13. The WTRU of claim 11, wherein the one or more measurements comprise reference signal received power (RSRP) measurements for each of the plurality of SSBs, and wherein the one or more conditions comprise a change in RSRP measurements for an SSB associated with an index exceeding a threshold.

14. The WTRU of claim 11, wherein the WTRU is further to:
determine a second SSB associated with a second index, and
transmit, to the wireless network, using the second SSB associated with the second index, a configured preamble on a Physical Random Access Channel (PRACH) resource associated with the second SSB.

15. The WTRU of claim 14, wherein the set of SSB indices is a first set of SSB indices, and the WTRU is further to:
receive configuration information indicative of a second set of SSB indices associated with one or more cell identifiers, wherein determining the second SSB associated with the second index comprises measuring an SSB with highest reference signal received power (RSRP) in the second set of SSB indices.

16. The WTRU of claim 15, wherein the first set of SSB indices is a subset of the second set of SSB indices.

17. The WTRU of claim 14, wherein the WTRU is further to:
transmit, to the wireless network, first information associated with the sensing measurements.

18. The WTRU of claim 17, wherein the first information associated with the sensing measurements comprise information indicating a cause of a connection request, the SSB associated with the first index and an associated cell identifier, and the measurements associated with the one or more conditions.

19. The WTRU of claim 17, wherein the WTRU is further to:
transmit, to the wireless network, second information comprising at least one Downlink-Reference Signal (DL-RS) configurations identifier.

20. The WTRU of claim 11, wherein the termination condition comprises at least one of receiving a message from the wireless network indicating termination of the sensing measurements, an expiry of a time period or a loss of connection to the one or more cells.
